(19) United States
(12) Patent Application Publication
(10) Pub. No.: US 2005/0208812 A1
(43) Pub. Date: Sep. 22, 2005

(54) Electronic plug with short-length screw locking

(75) Inventor: Othmar Gaidosch, Ostfildern (DE)

Correspondence Address: THE FIRM OF KARL F ROSS, 5676 RIVERDALE AVENUE, PO BOX 900, RIVERDALE (BRONX), NY, 10471-0900, US

(73) Assignee: Hirschmann Electronics GmbH & Co. KG

(21) Appl. No.: 10/913,154

(22) Filed: Aug. 5, 2004

(30) Foreign Application Priority Data
Aug. 9, 2003 (DE) 10336674.1

(51) Int. Cl. H01R 13/62

(52) U.S. Cl. 439/320

(57) ABSTRACT

A plug assembly in which a plug is engageable with a coupling and a locking nut engages a screw thread to secure the assembly together. A screw thread is set back from an end of the plug or coupling to ensure that the contact pin or pins of the plug will engage in the contact sleeve or sleeves of the coupling before the threads of the nut and screw engage. The result is a nut of reduced length which is easier to manipulate on locking or unlocking.

### FIELD OF THE INVENTION

My present invention relates to a plug system, especially for electronic devices, comprising a plug and a coupling which can be interfitted and in which the plug and coupling can be secured after connection by a locking nut or locking screw arrangement. More particularly, the invention relates to such a plug arrangement in which the locking nut has a reduced thread length.

### BACKGROUND OF THE INVENTION

Plug systems comprising plug and coupling which can be connected together, i.e. interfitted, to establish an electrical connection are widely used in electronic equipment of all types. Usually at least one of the plug and coupling members is provided on a cable and one or the other of the members can be provided on an electrical device to be connected to some other device or implement. Plug systems generally can be of the type known as E series round-plug connectors conforming, for example, to the standard IEC 61076-2-101.

Plug connectors under this standard can have a screw-locking facility which prevents the plug from being unintentionally withdrawn from the coupling.

For this purpose the plug and the coupling can be interconnected by a screw on one of the members and a nut on the other member with either the screw or the nut being rotatable.

In the conventional plug connector under the aforedescribed standard, the thread length of the nut is such that the threads of the nut and the screw engage before the pin contact of the plug engages the sleeve contact of the coupling and thus before electrical contact between the two is established. The engagement between the nut and the screw thus requires rotation of the screw to allow the pin to project into the sleeve and must be capable of generating sufficient force to enable a sealing effect between the sealing surfaces of the plug and coupling members. As a consequence the thread must be such that it can be fabricated by mass production and yet be sufficiently robust and strong to allow reliable sealing connections to be made to an industrial standard and prevent unintentional loosening or separation of the plug even in the presence of vibration.

Such screw locks have, however, a significant drawback in that they require long multiturn screw threads which are difficult to manipulate, complicate the connection between the plug and the coupling and do not allow a reliable insertion of the plug into the coupling without impediment by the securing screw and nut.

### OBJECTS OF THE INVENTION

It is, therefore, the principal object of the invention to provide a plug system including a plug member and a coupling member adapted to receive the plug member whereby the securing or locking nut and screw are so arrange 5 to permit more rational manipulation of the coupling, relatively rapid connection and locking and simplify insertion of the plug member into the coupling member.

Another object of the invention is to provide a plug system which is free from the drawbacks of the previously-described system, is of lower cost and is capable of ensuring a fully-locked state of the system.

### SUMMARY OF THE INVENTION

These objects and others which will become apparent hereinafter are attained in a plug system comprising a plug member having at least one contact pin and a coupling member having a contact sleeve adapted to receive the pin to establish an electrical connection therebetween, a locking screw on one of the members and a locking nut on the other member engageable with the screw, at least one of the screw elements, i.e. the screw or the nut, being set back from the front or end of the respective member by a distance such that the threads of the two elements first engage in a longitudinal connection after the two members have been sufficiently interfitted to electrically contact one another.

The invention also includes a plug which has its screw or nut element so set back and a coupling member which has its nut or screw element so set back that the threads of the screw element first engage after electrical contact is made between the pin of the plug and the sleeve of the coupling. A radially-extending circumferential seal can lie within the axial length of the nut.

According to the invention, therefore, the screw element of the nut or the screw is set back in the axial direction from the front end of the plug member or coupling member, i.e. the end of the member which is inserted into the other member, such that the screw connection can only be engaged (screwed together) after the contact members have been brought into engagement or electrical contacting relationship.

This set-back arrangement ensures that the front end of the plug and coupling members can be inserted one into the other so that there is at least partial axial insertion of the pin contact of the plug into the sleeve contact of the coupling before the actual thread interengagement of the screw and nut take place. This means that the screw locking can only occur when the plug and coupling are interfitted, at least in part longitudinally. If the nut and screw are then rotated relatively to draw them further together in the axial direction, the plug assembly can be fully tightened and the fully-locked position reached. Since the thread of the nut is shortened in axial length, fewer rotations are required to secure the plug connection and, upon rotation in the reverse direction, to release it.

### BRIEF DESCRIPTION OF THE DRAWING

The above and other objects, features, and advantages will become more readily apparent from the following description, reference being made to the accompanying drawing in which:

FIG. 1 is a side elevational view of a plug assembly according to the invention, partly seen in section;

FIG. 2 is a detailed view of the region shown in the circle II of FIG. 1 prior to connection of the assembly;

FIG. 3 is a cross sectional view of the plug and its mating connector after mutual engagement and before tightening of the locking nut; and

FIG. 4 is a view with the locking nut almost fully tightened onto the screw portion.

### SPECIFIC DESCRIPTION

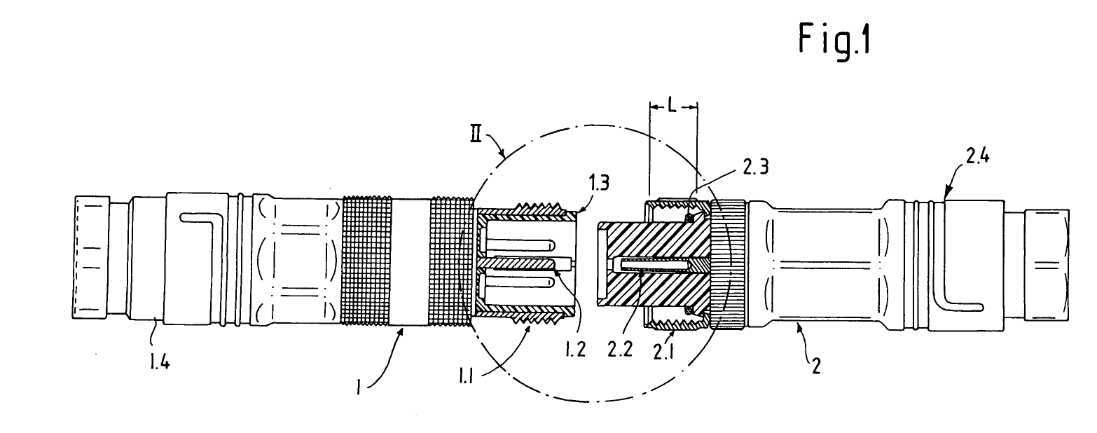

The plug assembly shown in FIG. 1 is of the round-plug type corresponding to the standard IEC 61076-2-101 for round plugs used in electronics and can comprise the plug 1 and a coupling 2 which receives the plug and forms the assembly together with the plug. The plug 1 can have a fitting 1.4 enabling its connection with a cable (not shown) and a similar fitting 2.4 of the coupling may also be connected to a cable or to the electronic component directly. For example, the fitting 2.4 can be mounted on the housing or on a printed circuit board or some other carrier for an electronic circuit.

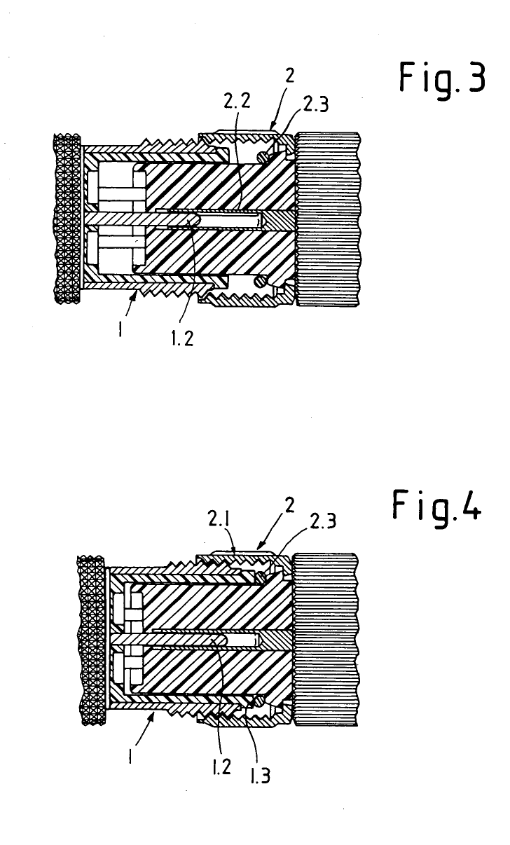

Of course the plug 1 may be mounted on the electronic circuit or device and the fitting 2.4 can be connected to a cable or to another portion of the device. As can be seen from FIG. 3, the coupling 2 can have a front end 3 (i.e. an end opposite the cable or the connection to the electronic device or circuit, which is received in a hollow portion of the front end of the plug 1.

More particularly, toward the front of the plug a screw 1.1 can be provided just inwardly of a sealing surface 1.3 of a cup-shaped member 1.4 which can be provided internally with ribs 1.5 adapted to be received in grooves (not shown) of an otherwise cylindrical body 2.5 of the coupling 2. The ribs 1.5 assist in alignment of the plug and the coupling 2.

The locking screw 1.1 is coaxial with the cup or plug housing 1.4 and is axially locked between a shoulder 1.6 at its rear end and a shoulder 1.7 of the cup 1.4 at the front end. If then locking nut 2.1 of the coupling is nonrotatable, the screw 1.1 on the housing 1.4 can be rotatable. Alternatively the screw 1.1 can be angularly fixed on the housing 1.4 if the nut 2.1 is rotatable.

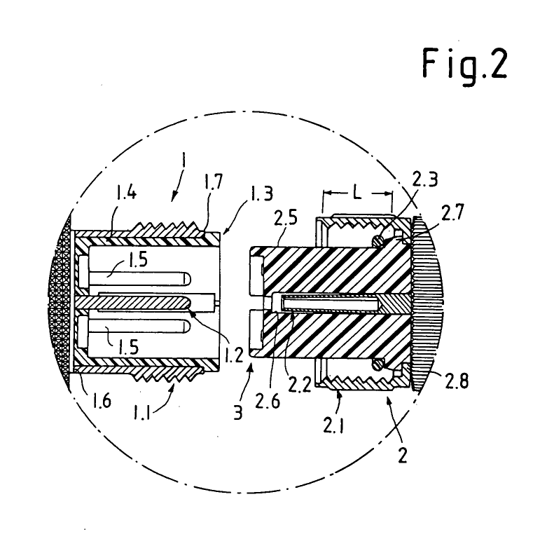

Coaxially with the screw 1.1 and the housing 1.4 is a contact pin 1.2. Alternatively a number of contact pins can be provided on the plug in the layout of the above-identified standard. The pin or pins 1.2 can be connected to respective conductors of a single conductor or multiconductor cable as required. The front end of the plug 1 (FIG. 2) is provided with a sealing surface engageable with an O-ring 2.3 of the coupling 2.

More particularly, the coupling 2 can comprise a coupling body or housing 2.5 which fits snugly in the housing 1.4 and is provided with passages 2.6 into which the pins 1.2 can be received and which, in turn, have conductors 2.2 in the form of sleeves, each of which can receive a respective contact pin 1.2 to form an electrical connection therewith. The body 2.5 can be composed of electrically nonconductive material and can have a shoulder 2.7 behind which an internally extending flange 2.8 of the internally threaded locking nut 2.1 can engage so that, while the nut is rotatable, it cannot move axially on the coupling 2. The other side of the shoulder 2.7 forms a seat for the O-ring 2.3.

FIGS. 2-4 make the functions of the part clear. The nut 2.1 is set back from the front end 3 so that, for the screw 1.1 to be engaged by the nut 2.1, the plug 1 must be inserted onto the coupling 2 at least until the contact pin or pins 1.2 engage in and electrically contact the sleeve or sleeves 2.2. The parts are inserted one into the other by manual force.

Only after the plug 1 and the coupling 2 have been received in one another so that the pin 1.2 is securely engaged in the respective sleeve 2.2, say to ½ or ⅔ of the interengaged length at full insertion, can the thread of the screw 1.1 be engaged in the nut 2.1 (FIG. 3). At this point the screw 2.1 can be rotated (FIG. 4) to draw the plug further onto the coupling until the face 1.3 comes to bear and compress the O-ring 2.3. This allows the length L of the threaded portion of the nut 2.1 to be greatly shortened relative to locking nut lengths of the prior art and thereby provided an economical advantage with respect to the nut fabrication. Since shorter threads are required, mass production of both the screw and the nut is facilitated. In addition, assembly is simplified and fewer rotations of the nut can lock the assembly and compress the O-ring so that the plug assembly requires less effort than has heretofore been the case.

1. A plug system comprising:
a plug member having at least one contact pin;
a coupling member axially interconnectable with said plug member and having at least one contact sleeve positioned to receive said contact pin and to establish an electrical connection therewith upon axial engagement of said plug member with said coupling member; and
a screw element having an eternal screw thread on one of said members and a nut element having an internal screw thread on the other of said members, at least one of said elements being rotatable on the respective member for engagement of the threads of said element, the thread of at least one of said elements being set back from an end of the respective member so that said members interengage sufficiently to establish an electrical connection between said pin and said sleeve before the threads of said elements engage to draw said members together upon relative rotation of said elements.

2. The system defined in claim 1 wherein said plug member is the member whose element has a thread set back from the end thereof engaging said coupling member.

3. The system defined in claim 1 wherein said coupling member is the member whose element has the thread thereof set back from the end of the coupling member engaging said plug member.

4. The system defined in claim 1 wherein said screw element is provided on said plug member and said nut element is provided on said coupling member.

5. The system defined in claim 4 wherein a circumferential seal is provided on said coupling member and is engageable by an end of said plug member upon tightening of said elements on one another.

6. The system defined in claim 5 wherein said nut element is rotatable and has an axial length, said seal lying within the axial length of said nut element.

7. The system defined in claim 6 wherein said plug member has a cylindrical cup opening toward said coupling member and formed with an end face engaging said seal, said coupling member having a body receivable in said cup and formed with a shoulder against which said seal is seated, said seal being an O-ring.

8. The system defined in claim 7 wherein said nut has an inwardly-extending flange engageable behind said shoulder, said nut elements being set back from an end of said body.
